(19) United States
(12) Patent Application Publication
(10) Pub. No.: US 2019/0234560 A1
(43) Pub. Date: Aug. 1, 2019

(54) CRYOGENIC FLUID PRESSURIZING SYSTEM

(71) Applicant: Thomas Byrne, London (GB)

(72) Inventor: Brian Clarke, Nottingham (GB)

(21) Appl. No.: 16/330,929

(22) PCT Filed: Sep. 6, 2017
(86) PCT No.: PCT/US17/50363

§ 371 Date: Mar. 6, 2019

Related U.S. Application Data
(60) Provisional application No. 62/383,660, filed on Sep. 6, 2016.

(51) Int. Cl. F17C 5/02; F17C 5/06; F17C 7/02; F17C 9/02; F25B 45/00; F25D 3/10

(52) U.S. Cl. CPC F17C 5/02; F17C 5/06; F17C 7/02; F02M 21/0221; F25B 45/00; F25D 3/102; F17C 9/02

(57) ABSTRACT

Aspects of the present invention provide a cryogenic fluid delivery system configured to provide a predetermined amount of liquid cryogenic fluid from a reservoir to an apparatus (e.g., a vapor ring of a cryogenic chiller system). A controlled high pressure gas burst is applied to the reservoir to push a predetermined amount of cryogenic fluid from the reservoir to the apparatus.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims priority to and hereby incorporates by reference in its entirety U.S. Provisional Patent Application No. 62/383,660 entitled “CRYOGENIC FLUID PRESSURIZING SYSTEM” filed on Sep. 6, 2016. This application hereby incorporates by reference in its entirety U.S. patent application Ser. No. 14/469,206 filed on Aug. 26, 2014 entitled “EXPANDING GAS DIRECT IMPINGEMENT COOLING APPARATUS.”

### TECHNICAL FIELD

The present invention relates generally to repeatedly delivering cryogenic fluid to a container. More particularly, this invention pertains to a cryogenic fluid delivery system for repeatedly delivering measured quantities of a cryogenic fluid to an expanding gas direct impingement cooling apparatus (e.g., a chiller system).

### BACKGROUND ART

Referring to prior art FIG. 1, a prior art expanding gas direct impingement cooling apparatus (e.g., cryogenic chiller) includes a Wessington PV 60 self-pressurizing cryogenic vessel 2, a cryogenic regulator 8, a safety gas train 104, a cryogenic pressure release safety valve 7, and a cabinet containing items to be chilled 100. The self-pressurizing vessel 2, safety gas train 104, and cabinet 100 are interconnected with cryogenic hoses which are optionally vacuum insulated. The apparatus may also include a cryogenic temperature monitor and a cryogenic bypass valve. The cabinet 100 may also include an exhaust fan and electronically controlled door lock. A proprietary user interface 130 and control software operated by a controller opens and closes the cryogenic solenoid valve 14 which allows a precise quantity of pressurized cryogenic fluid (e.g., liquid nitrogen), determined as a function of the input to the user interface 130, to flow from the Wessington PV 60 self-pressurizing cryogenic vessel 2 to the cabinet 100. The control software locks the cabinet door for a period of time determined as a function of the input to the user interface 130 while the cryogenic fluid diffuses about the cabinet 100 and items in the cabinet 100. When the controller unlocks the cabinet door and a user opens the door, the exhaust fan draws the gas inside the cabinet 100 to an area away from the user. That is, when liquid nitrogen boils into gaseous nitrogen, the exhaust fan draws the nitrogen gas away from the user when the user opens the cabinet 2 so that the air around the user does not become overly saturated with nitrogen. In one embodiment, the entire control system is powered by a 12 volt DC battery which can operate the cabinet in excess of 18 working hours with no additional power input (e.g., solar charging or generator power).

Wessington type self-pressurizing vessels operate on gravity fed self-pressurizing systems using an evaporative coil usually soldered to the external walls and stainless steel pressure vessel. Typically, these systems operate in a range of 60 to 100 psi. In the prior art cryogenic chiller apparatus application, the pressure is reduced by the cryogenic regulator 8 to around seven psi. The liquid nitrogen reservoir is formed from two walls of stainless steel producing an inner wall 22 and an outer wall 20. Atmosphere (air) is evacuated from the space 21 between the walls producing a vacuum typically greater than 10.5 psi. This vacuum provides sufficient insulation to preserve the liquid nitrogen in the vessel 2 for up to 30 days. A pressure raising system of the vessel creates the pressure it requires to operate by boiling off small amounts of liquid nitrogen which expands to create 700 times its volume in nitrogen gas. The pressure raising system incorporates a pressure raising coil 4 which is soldered to the external stainless steel wall 20. Through these soldered attachments the external heat from the atmosphere is used to boil the liquid nitrogen (−196 C) into its gaseous form within the coil 4. This part of the system is controlled by a pressure regulator 8. Essentially, when either gas or liquid are drawn from the vessel 2, there is a reduction in the pressure of gas in the vessel 2 and, compelled by gravity, liquid nitrogen falls into the pressure raising coil 4 causing liquid nitrogen to evaporate and rise up the coil 4 as nitrogen gas to the top of the vessel 2. This cycle continues until the vessel's internal pressure controlled by the pressure regulator 8 meets 60 psi. The process of evaporation and gas generation is fully automatic and occurs immediately as use of the stored cryogenic fluid takes place.

In the system of FIG. 1, the safety gas train 104 may include a bursting disc 5, a safety relief valve 7, and a pressure gauge 6. Additionally, the system may include a liquid fill valve 1. The cryogenic regulator 8 may be connected to the pressure raising coil 4 by an adjustable pressure regulator 12, and the pressure regulator 8 is connected to a top of the container 2 to deliver pressurized gas back to the container 2 via a gas vent 3.

In the system of FIG. 1, a stainless steel self-pressurizing vessel of 60 liters capacity is used as a cryogenic fluid vessel 2 or reservoir. The vessel is connected by a non-insulated line (optionally vacuum insulated) to a cryogenic gas train set 102 as described above. The gas train valve set is controlled by an integrated circuit system (i.e., controller storing precise predetermined routines) receiving input from a Graphical User Interface (GUI) 130. When activated via the GUI, the controller actuates the valves 14 of the gas train set 102 and safety system to allow a predetermined, precise quantity of cryogenic fluid (e.g., liquid nitrogen) to flow, under pressure, to a vaporizing ring (e.g., gasification manifold ring) inside the cabinet 100. Super cooled vapor instantly floods the cabinet 100 and the beverages contained within the cabinet 100 are rapidly chilled to the desired temperature as determined by the user input to the GUI. The system, which operates on a 12 volt battery is fast, efficient, user friendly, and relatively maintenance free. As such, it is well suited to outdoor use, and the cabinet can be manufactured to any size, whether small (e.g., for portable use) or large (e.g., for fixed installations).

### DISCLOSURE OF THE INVENTION

Aspects of the present invention provide a cryogenic fluid delivery system configured to provide a predetermined amount of liquid cryogenic fluid from a reservoir to an apparatus (e.g., a vapor ring of a cryogenic chiller system). A controlled pressure is applied to the reservoir to push a predetermined amount of cryogenic fluid from the reservoir to the apparatus.

In one aspect, a cryogenic fluid delivery system includes a cryogenic fluid reservoir, a pressurized gas source, and a control valve. The cryogenic fluid reservoir is configured to fluidly connect to a cryogenic apparatus. The control valve is configured to selectively fluidly connect the pressurized gas source to the cryogenic fluid reservoir such that cryogenic fluid in the cryogenic reservoir is pushed into the cryogenic apparatus by pressurized gas from the pressurized gas source entering the cryogenic fluid reservoir.

In another aspect, a method of delivering cryogenic fluid to a cryogenic apparatus includes fluidly connecting a cryogenic fluid reservoir to a cryogenic apparatus. A pressurized gas source is connected to the to the cryogenic fluid reservoir via a control valve. The control valve selectively fluidly connects the pressurized gas source to the cryogenic fluid reservoir according to input from a controller such that cryogenic fluid in the cryogenic reservoir is pushed into the cryogenic apparatus by pressurized gas entering the cryogenic fluid reservoir from the pressurized gas source.

### BRIEF DESCRIPTION OF THE SEVERAL VIEWS OF THE DRAWINGS

FIG. 1 is a schematic diagram of a prior art cryogenic fluid vessel and chiller system.

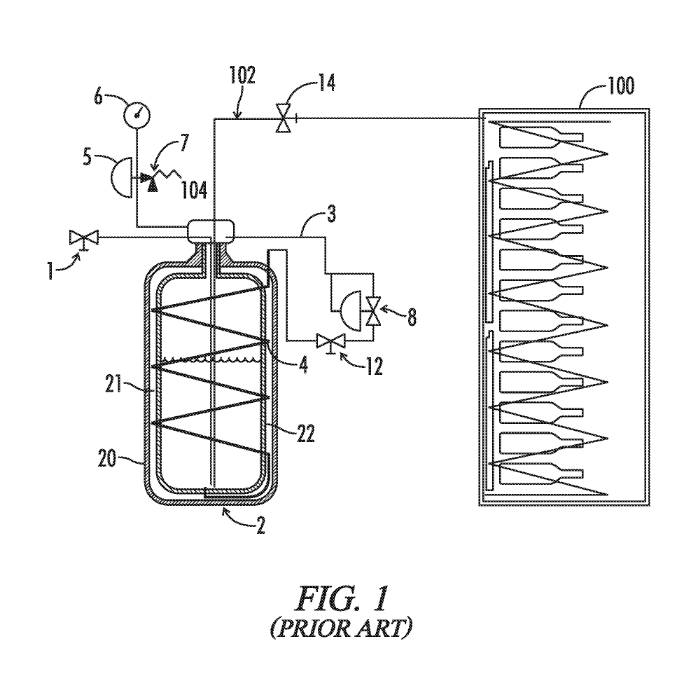

FIG. 2 is a schematic diagram of cryogenic fluid vessel and chiller system utilizing a flash chamber.

FIG. 3 is a schematic diagram of a pump driven cryogenic fluid vessel and chiller system.

Reference will now be made in detail to optional embodiments of the invention, examples of which are illustrated in accompanying drawings. Whenever possible, the same reference numbers are used in the drawing and in the description referring to the same or like parts.

### BEST MODE FOR CARRYING OUT THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

As described herein, an upright position is considered to be the position of apparatus components while in proper operation or in a natural resting position as described herein. Vertical, horizontal, above, below, side, top, bottom and other orientation terms are described with respect to this upright position during operation unless otherwise specified. The term “when” is used to specify orientation for relative positions of components, not as a temporal limitation of the claims or apparatus described and claimed herein unless otherwise specified. The terms “above”, “below”, “over”, and “under” mean “having an elevation or vertical height greater or lesser than” and are not intended to imply that one object or component is directly over or under another object or component.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Terms such as “providing,” “processing,” “supplying,” “determining,” “calculating” or the like may refer at least to an action of a computer system, computer program, signal processor, logic or alternative analog or digital electronic device that may be transformative of signals represented as physical quantities, whether automatically or manually initiated.

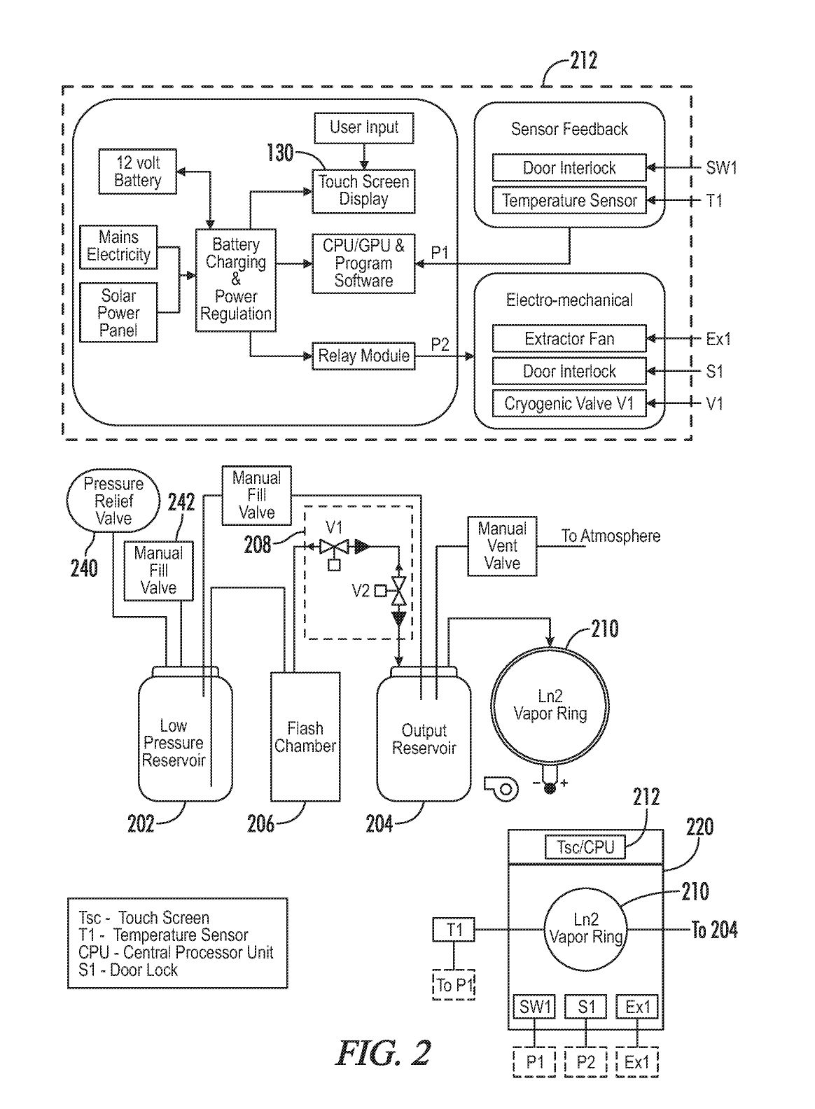

Referring to FIG. 2, in one embodiment, a cryogenic delivery system 200 includes two 2.5 liter stainless steel vacuum insulated cryogenic fluid (e.g., liquid nitrogen) tanks or reservoirs 202, 204 together with a flash chamber 206, thermocouple, and control valve. The two reservoirs 202, 204 are fluidly connected to an aluminum flash chamber 206. The flash chamber 206 draws low pressure liquid from the first tank 202, and the liquid expands in the flash chamber 206 to gas at 800 times the volume of liquid drawn. The gas contained in the flash chamber 206 is used to pressurize the second tank 204 by operation of a solenoid valve 208. When the solenoid valve 208 opens, this gas under pressure is then used to pressurize the second tank/reservoir 204, pushing the liquid nitrogen from the second tank/reservoir 204 directly to a vapor ring 210 and into a chiller cabinet 220 in which the vapor ring 210 resides.

The low pressure 202 and high pressure reservoirs 204 (i.e., the second tank 204 and the first tank 202) are separated by a one-way check valve 244 which does not allow the high-pressure gas to return to the low pressure vessel. The rate at which liquid nitrogen flows from the second reservoir 204 is determined by the pressure pushing the gas into the vapor ring 210. Pressure in the first reservoir 202 is detected by a pressure sensor 242 which sends data to a controller 212 that regulates operating pressure by opening and closing a dump valve 240. Principally, control over the chiller system 200 is managed by the controller 212 via a single 12 volt DC valve V1 which opens and closes in response to inputs received from the controller. A second valve V2 is normally closed and used as a fail safe to prevent dumping of cryogenic fluid in the event of a power loss to the system. The first valve V1 and second valve V2 form the solenoid valve 208 in one embodiment.

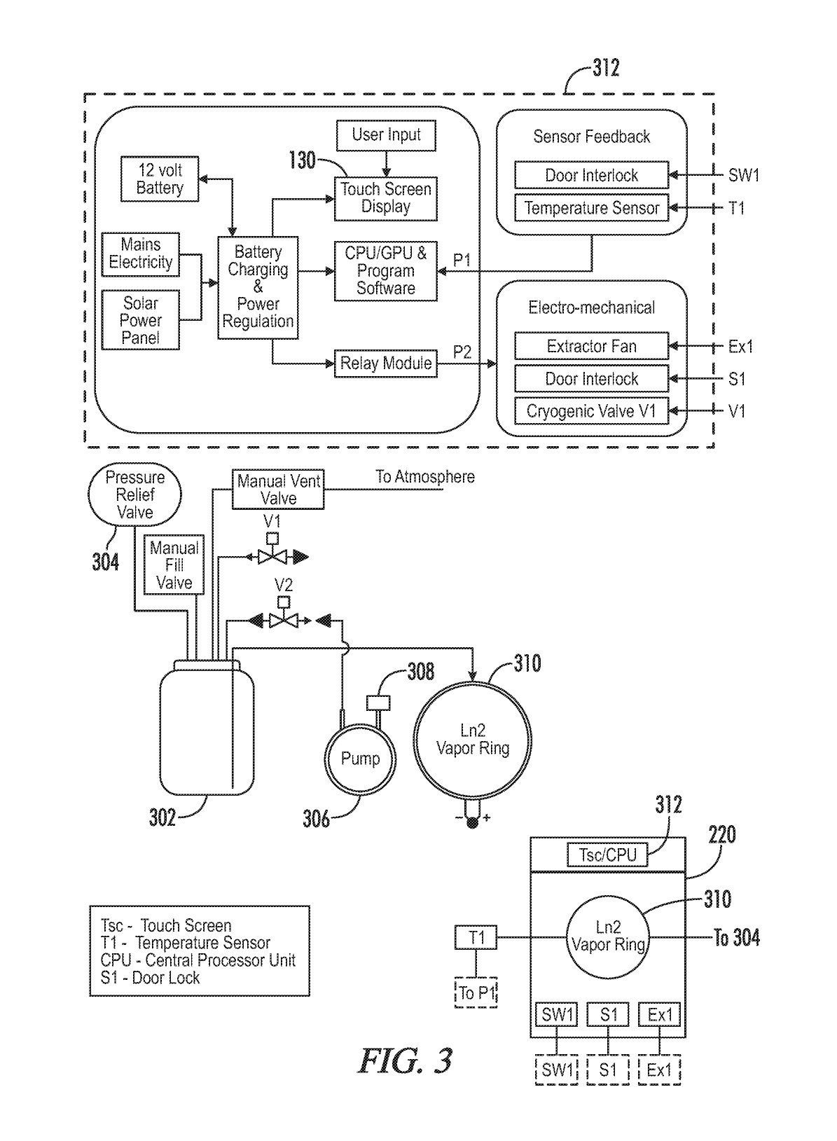

Referring to FIG. 3, in another embodiment, a cryogenic chiller system 300 includes a stainless steel dewar (i.e., vessel 302) capable of withstanding up to 60 psi, a pressure relief valve 304 which ensures the pressure within the vessel 302 does not exceed 10 psi, and a pump 306. The high efficiency diaphragm pump 306 draws atmospheric air in through a Hydrophobic Filter 308 which removes any moisture from the air and pumps the desiccated air under pressure into the dewar 302. The pressurized, dessicated air from the pump 306 drives liquid nitrogen (i.e., cryogenic fluid) from the dewar 302 into the vapor ring 310. The high flow rate and capacity of the pump 306 make the system very responsive to the control inputs from the controller 312. Peak flow is achieved within seconds, and when flow is no longer required, two control valves 312, 314 are actuated. The valves 312, 314 cooperate to shut off the pressure from the pump 306 to the dewar 302 and vent the dewar 302 to atmosphere, allowing for a near instantaneous release of pressure from the dewar 302.

It will be understood by those of skill in the art that navigating between user interface views of the GUI to activate the controller of the cryogenic chiller system is accomplished by selecting a tab or object in a current user interface view corresponding to another user interface view, and in response to selecting the tab or object, the user interface updates with said another user interface view corresponding to the selected tab or object.

It will be understood by those of skill in the art that providing data to the system or the user interface may be accomplished by clicking (via a mouse or touchpad) on a particular object or area of an object displayed by the user interface, or by touching the displayed object in the case of a touchscreen implementation.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although embodiments of the present invention have been described in detail, it will be understood by those skilled in the art that various modifications can be made therein without departing from the spirit and scope of the invention as set forth in the appended claims.

A controller, processor, computing device, client computing device or computer, such as described herein, includes at least one or more processors or processing units and a system memory. The controller may also include at least some form of computer readable media. By way of example and not limitation, computer readable media may include computer storage media and communication media. Computer readable storage media may include volatile and nonvolatile, removable and non-removable media implemented in any method or technology that enables storage of information, such as computer readable instructions, data structures, program modules, or other data. Communication media may embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media. As used herein, server is not intended to refer to a single computer or computing device. In implementation, a server will generally include an edge server, a plurality of data servers, a storage database (e.g., a large scale RAID array), and various networking components. It is contemplated that these devices or functions may also be implemented in virtual machines and spread across multiple physical computing devices.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention of a new and useful CRYOGENIC FLUID PRESSURIZING SYSTEM it is not intended that such references be construed as limitations upon the scope of this invention except as set forth in the following claims.

What is claimed is:

1. A cryogenic fluid delivery system comprising:
a cryogenic fluid reservoir fluidly configured to connect to a cryogenic apparatus;
a pressurized gas source; and
a control valve configured to selectively fluidly connect the pressurized gas source to the cryogenic fluid reservoir such that cryogenic fluid in the cryogenic reservoir is pushed into the cryogenic apparatus.

2. The cryogenic fluid delivery system of claim 1, wherein:
the pressurized gas source is a diaphragm pump configured to draw in ambient air through a hydrophobic filter.

3. The cryogenic fluid delivery system of claim 1, wherein:
the pressurized gas source comprises:
a container of cryogenic fluid; and
a flash canister configured to receive cryogenic fluid from the container and expand the received cryogenic fluid to pressurized gas.

4. The cryogenic fluid delivery system of claim 1, further comprising:
a user interface configured to receive input from a user selecting a predetermined cryogenic routine; and
a controller configured to operate the control valve according to the user input received via the user interface; wherein:
the cryogenic apparatus is a chiller cabinet comprising a vapor ring, wherein the vapor ring is fluidly connected to the cryogenic fluid reservoir.

5. A method of delivering cryogenic fluid to a cryogenic apparatus, said method comprising:
fluidly connecting a cryogenic fluid reservoir to a cryogenic apparatus;
connecting a pressurized gas source to the cryogenic fluid reservoir via a control valve; and
selectively, via the control valve, fluidly connecting the pressurized gas source to the cryogenic fluid reservoir according to input from a controller such that cryogenic fluid in the cryogenic reservoir is pushed into the cryogenic apparatus by pressurized gas entering the cryogenic fluid reservoir from the pressurized gas source.

6. The method of claim 5, wherein:
the pressurized gas source is a diaphragm pump configured to draw in ambient air through a hydrophobic filter.

7. The method of claim 5, wherein:
the pressurized gas source comprises:
a container of cryogenic fluid; and
a flash canister configured to receive cryogenic fluid from the container and expand the received cryogenic fluid to pressurized gas.

8. The method of claim 5, further comprising:
receiving input at a user interface from a user, said user input selecting a predetermined cryogenic routine;
selectively via the controller, operating the control valve according to the user input received via the user interface; wherein:
the cryogenic apparatus is a chiller cabinet comprising a vapor ring, wherein the vapor ring is fluidly connected to the cryogenic fluid reservoir.
